(19) United States
(12) Patent Application Publication
(10) Pub. No.: US 2020/0130292 A1
(43) Pub. Date: Apr. 30, 2020

(54) COMPOSITE MATERIAL COMPRISING PRE-IMPREGNATED WOVEN FIBERS

(71) Applicants: SAFRAN, Paris (FR); Safran Nacelles, Gonfreville L'orcher (FR)

(72) Inventors: Bertrand DESJOYEAUX, MOISSY-CRAMAYEL (FR); Géraldine OLIVEUX, MOISSY-CRAMAYEL (FR); Cedric THOMAS, MOISSY-CRAMAYEL (FR)

(73) Assignees: SAFRAN, PARIS (FR); Safran Nacelles, GONFREVILLE L'ORCHER (FR)

(21) Appl. No.: 16/730,618

(22) Filed: Dec. 30, 2019

Related U.S. Application Data
(63) Continuation of application No. PCT/FR2018/051625, filed on Jun. 29, 2018.

(30) Foreign Application Priority Data
Jun. 30, 2017 (FR) 17/56227

(51) Int. Cl. B29C 70/12; B29C 70/46; D03D 15/00

(52) U.S. Cl. CPC B29C 70/12; D03D 15/00; B29C 70/46

(57) ABSTRACT

A material of pre-impregnated woven fibers for a part is in the form of a fibrous mat having at least one layer of several pieces of fibrous fabric pre-impregnated with resin. At least one portion of the fabric has a low-shrinkage contexture. The pieces of fabric are positioned parallel with the plane (X, Y) of the fibrous mat and orientated in different directions in the plane (X, Y).

### CROSS-REFERENCE TO RELATED APPLICATIONS

This application is a continuation of International Application No. PCT/FR2018/051625, filed on Jun. 29, 2018, which claims priority to and the benefit of FR 17/56227 filed on Jun. 30, 2017. The disclosures of the above applications are incorporated herein by reference.

### FIELD

The present disclosure relates to a material with ordered pre-impregnated woven fibers for making parts of complex geometry and which may have variable thicknesses.

### BACKGROUND

The statements in this section merely provide background information related to the present disclosure and may not constitute prior art.

In order to manufacture parts made of a fibrous composite material (or ordered discontinuous fibers) with complex geometry, in particular with variable thickness, in the aeronautical field, it is known to use a molding method including a step of thermocompressing fibrous materials pre-impregnated with a thermosetting resin.

It is known to use a pre-impregnated fibrous material based on continuous fibers in the forms of laps of unidirectional fibers or fabrics, but the drape-molding in successive layers makes difficult and expensive, the making of composite parts having variable thicknesses. It is necessary to cut and stack several layers of pre-impregnated fibrous material having a shape adapted to the local thicknesses.

Another drawback is the possibility of increased delamination in the areas of variable thickness located on the edge of the part and a local deformability of the material and of the stacking limited by the continuity of the fibers.

In order to solve this issue, it is possible to use discontinuous unidirectional fibers in the form of “mat” and impregnated with a thermosetting resin to form a composite of the HexMC® type, for example.

It is also possible to use discontinuous unidirectional fibers in the form of scattered sticks (such as a Mikado) and impregnated with a thermoplastic resin to form a composite of the Xycomp® type, for example.

The molding method then comprises a step of cutting fiber pieces in laps or cables of unidirectional fibers impregnated with resin.

However, the control of the distribution of the orientations of the fibers is difficult and does not allow obtaining composites having almost isotropic properties in the plane, in particular in the case of composites having a lower thickness.

The patent FR 2 770 802 is also known, disclosing a method for molding a part from a nonwoven lap of pre-impregnated reinforcing fibers by means of a thermosetting or thermoplastic matrix.

The method comprises a step of cutting the lap so as to form a multiplicity of discrete elements and a step of placing the discrete elements according to a random and three-dimensional arrangement directly in the mold.

This step is followed by a step of heating the reinforcing fibers and the matrix and of compression in the mold enabling the consolidation of the material to the desired shape.

However, this method results in a material in which the fibers are randomly oriented in the three directions of the space (X, Y, Z), which does not allow obtaining controlled and high mechanical properties in particular directions and, in particular, in the planes of the parts.

These methods do not allow obtaining a transformed product that offers at least high orthotropic or even almost isotropic properties in main surfaces for 3D geometries of parts of variable thicknesses comprising in particular lower thicknesses.

### SUMMARY

This section provides a general summary of the disclosure and is not a comprehensive disclosure of its full scope or all of its features.

The present disclosure provides a material made in particular from woven fibers pre-impregnated with resin.

According to the present disclosure, the material is in the form of a fibrous mat comprising at least one layer of several/a plurality of pieces of fibrous fabric pre-impregnated with a matrix or resin, at least one portion of the fabric forming the fibrous mat having a low-shrinkage contexture. These fabric pieces are positioned parallel to the plane (X, Y) of the fibrous mat and oriented according to different directions in this plane (X, Y).

The mat according to the present disclosure may also include one or more of the following features, which can be considered alone or combined with each other:

the entire fabric used to form the mat of pre-impregnated fabric pieces has a low-shrinkage contexture;

the used fabric is a contexture of carbon fibers, glass fibers, aramid fibers, basalt fibers, ceramics, alone or in combination;

the fibers constituting the fabric comprise continuous filaments or discontinuous filaments;

the ratio between the length and the thickness of the fabric pieces of the mat is substantially comprised between 60 and 250;

the ratio between the length and the thickness of the fabric pieces of the mat is substantially comprised between 80 and 200;

the ratio between the length and the thickness of the fabric pieces of the mat is substantially comprised between 100 and 180;

the width of the fabric pieces of the mat is greater than the quarter of their length;

the width of the fabric pieces of the mat is greater than half their length;

the width of the fabric pieces of the mat is substantially equal to the length;

the fabric pieces constituting the mat have a polygonal, such as rectangular, hexagonal, or triangular shape;

the fibrous mat has an average surface mass which is at least 2 times greater than the surface mass of the constituent fabric and less than 10 times the surface mass of the constituent fabric;

the fibrous mat has an average surface mass comprised between 1 kg/m² and 3 kg/m²;

the fibrous mat comprises one or several layer(s) of pre-impregnated woven fiber pieces which are agglomerated and bonded to each other so that it has almost isotropic properties in the plane (X, Y) thanks to the orientation of the fabric pieces including, on the one hand, for each fabric piece, two orientations of fibers substantially perpendicular to each other, on the other hand, the pieces close to each other have different fiber directions providing the constituted composite material with a stiffness in the same range of magnitude, regardless of the direction in the plane (X, Y), representative of an isotropic material in the plane (X, Y);

the mat may also comprise pieces of pre-impregnated unidirectional fiber laps; and/or

the mat has in any area of at least 2 cm² (for example 1.4 cm×1.4 cm), 4 distinct directions of fibers forming angles of more than 15° therebetween.

The resin is constituted by a thermosetting polymer or a thermoplastic polymer.

The present disclosure also concerns a part made of a material with pre-impregnated woven fibers.

According to the present disclosure, the part made of a material with pre-impregnated woven fibers is made by thermocompression of at least one mat or piece of mat of a material constituted by pre-impregnated woven fibers cut into pieces as defined above.

Advantageously, the part made of a pre-impregnated woven fiber material comprising at least one mat piece has almost isotropic properties according to certain planes thanks to the thermocompression of the mat offering fibers in multiple orientations in the plane of the mat of the molded part.

The part made from the mat as previously defined has high and homogeneous mechanical strength properties, including in areas of small thickness.

The present disclosure allows making parts of variable thickness up to about 10 mm and is particularly advantageous for the parts having at least locally small thicknesses up to one to twice the thickness of the fabric constituting the mat.

The present disclosure thus allows making parts with complex geometries at high performances by a simple and inexpensive method.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a mat roll according to the present disclosure;

FIG. 2 is a detail view of the mat constituted by a stack of fabric pieces according to the present disclosure;

FIG. 3 is a transparent detail view of the mat of FIG. 2 with arrows representative of the orientations of fibers according to the present disclosure;

FIGS. 4a to 4f illustrates possible forms of parts made from the material according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 shows a partially unwound roll of fibrous mat 2 according to the present disclosure.

The mat is constituted by fabric pieces 3 of fibers pre-impregnated with a matrix or resin disposed parallel to the plane (X, Y) of the mat.

The fabric pieces 3 are stacked on top of each other and are disposed parallel to the plane (X, Y).

The matrix may be a thermosetting resin, in particular epoxy, or a thermoplastic resin such as PEI, PAEK, PA, PEEK, among others, or a ceramic precursor.

The fibers may be carbon fibers, glass fibers, Kevlar fibers, ceramic fibers such as SiC (silicon carbide) or alumina oxides or the like.

Optionally, the fibers are called continuous fibers, that is to say rovings constituted by sets of parallel or twisted continuous filaments.

According to another variant, the fibers are called discontinuous fibers, that is to say rovings constituted by a filament aggregate of finite length held together by twisting and/or sizing and/or taping. For example, it may comprise Verranne type glass fibers or ‘cracked fibers’ type carbon fibers (stretch broken fibers).

The fabrics may be of one single type of fibers or of combinations of fibers intertwined according to patterns such as canvas, twill, satin or braiding, or else stacked according to different directions and sewn (NCF).

Advantageously, the fibers are crossed and intertwined according to two perpendicular directions and in one form in substantially identical proportions according to each of the two directions.

The fibers inside the fabric pieces 3 are disposed substantially parallel to the plane (X, Y).

According to another variant, the fibrous mat may be a combination of pre-impregnated fiber fabric pieces and pre-impregnated unidirectional fiber lap pieces meeting similar geometrical characteristics, the fibers capable of being of the same nature or of different nature as previously described.

The fabrics are characterized by low-shrinkage contextures such as twill 2×2, twill 3×1, satin of 5 or of 8.

The term fabrics having low-shrinkage contextures, means contextures in which the corrugations of the threads, or rovings, of one direction of the fabric crossing the rovings of the other direction of the fabric impart a slight relief in thickness to the fabric.

Such a feature is obtained, on the one hand, using rovings having an envelope section of the filaments, which make up the rovings or threads, substantially ellipsoidal and very flattened, and in one form by a weave pattern of the fabric in which most of the weft rovings pass over at least two warp rovings such as twill 2×2, twill 3×1, satin of 5 or of 8.

Such textures then have a shrinkage of less than 5%. In one form, the shrinkage is less than 2%. In a further form, the shrinkage is less than 0.7%.

Thus, the fabrics offer, on the one hand, good mechanical properties in the plane, and have good deformation capacities by unstraining the fibers between the warp and weft directions during the compression of the material.

Advantageously, thanks to these contextures, the fabrics of pre-impregnated fibers have an apparent thickness in the initial state smaller than 200% of the thickness of the associated fabric piece after thermocompression. For example, in one form, the pre-impregnated fiber fabric has an initial thickness smaller than 170% of the thickness of the fabric piece after thermocompression.

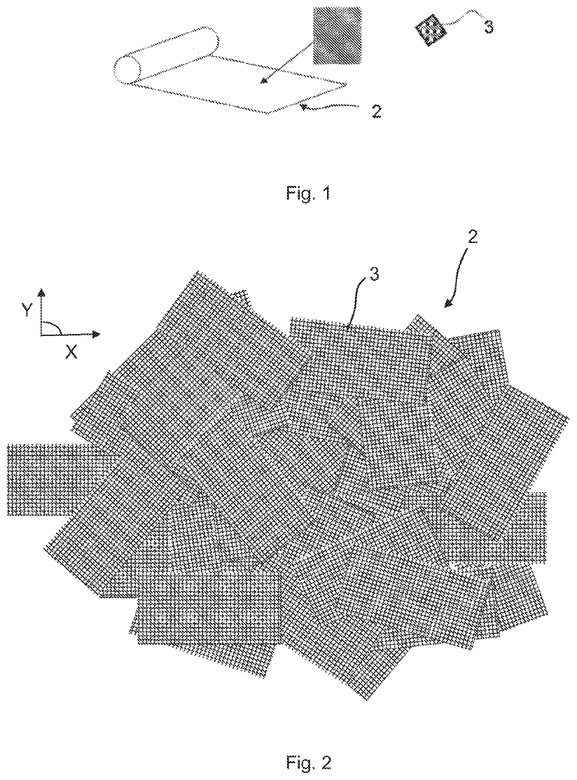

FIG. 2 shows a detail of an example of a fibrous mat 2 having a stack with superposition of several layers of several fabric pieces 3 oriented according to different directions in the plane (X, Y) and the pieces partially covering each other.

The fabric pieces 3 have a polygonal shape and in one form have a quadrilateral shape.

In another form, the fabric pieces 3 have a triangular or rectangular or hexagonal shape.

The dimensions of the fabric pieces 3 are such that the ratio between their largest length and the thickness of the fabric layer of the fibrous mat 2 is substantially comprised between 60 and 250.

In one form, the fabric pieces 3 have a length at least 80 times greater than the thickness of the woven fibers lap.

In another form, the fabric pieces 3 have a length at least 100 times greater than the thickness of the woven fiber lap.

The dimensions of the fabric pieces 3 are such that the ratio between their largest length and their width is less than or equal to 4.

In one form, the width of the fabric pieces 3 of the fibrous mat 2 is greater than half their length.

In another form, the width of the fabric pieces 3 of the fibrous mat 2 is substantially equal to their length.

The fabric pieces 3 are cut in fabrics as previously defined. They have a surface mass of dry fabric comprised between 0.160 kg/m² and 0.6 kg/m².

The fabric pieces 3 are impregnated with a thermosetting or thermoplastic resin according to a resin/fiber volume ratio comprised between 0.35 and 0.55.

The fibrous mat 2 constituted from these fabric pieces 3 is characterized in that the fabric pieces 3 are disposed in the plane of the fibrous mat 2 or substantially parallel to the plane of the fibrous mat 2.

The fibrous mat 2 has a surface mass ranging from 1 to 3 kg/m². Its surface mass is at least greater than 2 times the surface mass of the constituent fabric, and less than 10 times the surface mass of the constituent fabric, and in one form, the surface mass of the fibrous mat 2 is between 3 and 8 times the surface mass of the constituent fabric.

The fibrous mat 2 has a random distribution of the fabric pieces 3 in the plane of the fibrous mat 2, resulting in random orientations of the main directions of the fibers of each fabric piece 3 in the plane of the mat and an overlap of the fabric pieces 3 therebetween.

FIG. 3 shows an example of a fibrous mat 2, highlighting in transparency the different fabric pieces 3 and the respective orientations of the fibers of each individual piece.

The fabric pieces 3 are disposed parallel to the plane of the fibrous mat 2, providing step by step coverages between the fabric pieces 3. The orientations of the fabric pieces 3 and the overlap of pieces at least two by two in the plane of the mat allow obtaining, in any square area of at least 1.4 cm inside (2 cm²), at least 4 distinct directions of fibers forming angles of more than 15° therebetween.

As shown in the dotted square 9 in FIG. 3, the fibers inscribed inside the dashed square 9 are in multiple directions, herein more than 4. Considering fibers of two fabric pieces 3 in this dotted square 9, it is possible to find two fabric pieces 3 forming an angle of up to 45°.

Because each fabric piece 3 itself includes two directions of fibers substantially perpendicular to each other, the fibrous mat 2, in this dotted square 9, has fiber orientations in so many directions parallel to the plane of the mat, which provides homogenized properties of stiffness and substantially isotropic resistance in this plane.

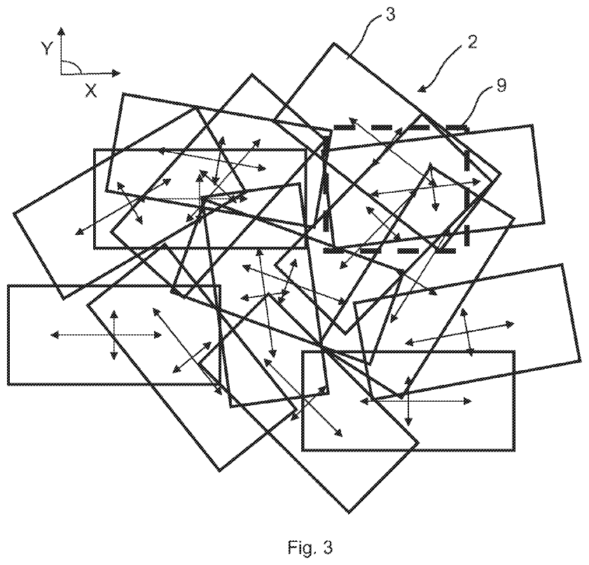

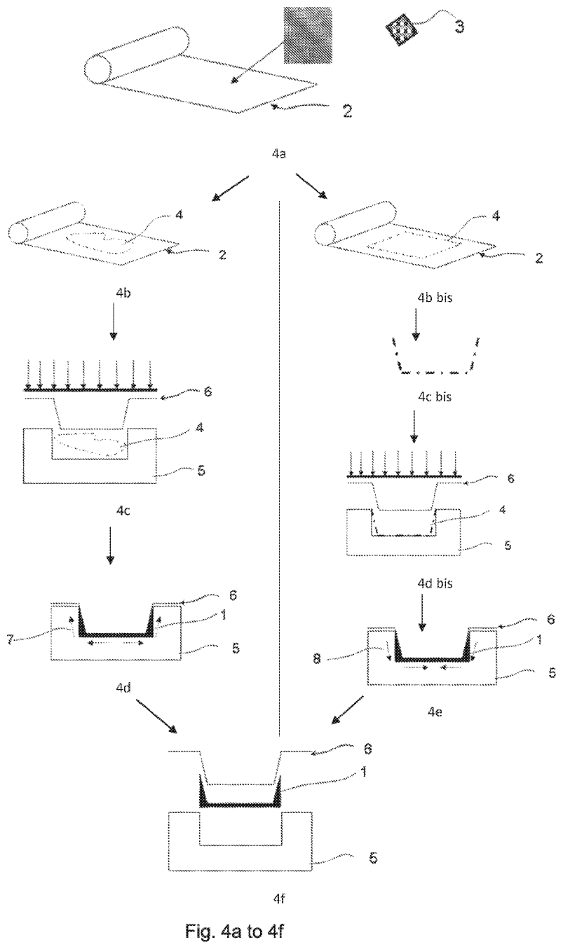

The material according to the present disclosure enables in particular the making of parts according to the manufacturing method described in FIGS. 4a to 4f.

It comprises a cutting step (FIG. 4b or 4b bis) of at least one flank of the fibrous mat 4 or blank in the fibrous mat 2 formed by the fabric pieces 3.

The manufacturing method alternatively comprises a stack of several flanks of fibrous mat 4 or blanks.

The manufacturing method alternatively comprises a preforming step (FIG. 4c bis) of the fibrous mat flanks 4 or of the stack of fibrous mat flanks 4.

The manufacturing method alternatively comprises a step of assembling the preforms obtained in the previous step (FIG. 4c bis).

The implementation comprises a step (FIG. 4c or 4d bis) of arranging the flanks of fibrous mat 4 or blanks, or preforms or preform assembly in a mold 5, 6.

The manufacturing method comprises a step (FIG. 4d or 4e) of thermocompressing the flanks of fibrous mat 4 or blanks, or preforms or preform assembly to form a woven fiber based composite part 1.

The mold 5, 6 is closed and a compression and a thermal cycle are applied on the material to compact it and make it creep/deform, in the directions 7 or 8 represented in FIGS. 4d and 4e respectively, to fill the volume of the imprint of the mold 5, 6.

The compression may be uni-axial or multi-axial depending on the closure kinematics of the tooling/mold.

In one form, the compression directions are locally perpendicular or substantially perpendicular to the plane of the flanks of the fibrous mat 4, blanks or preforms.

A polymerization thermal cycle is carried out when the resin is a thermosetting or solidification resin when the resin is a thermoplastic resin.

The thermocompression step may be carried out in an autoclave or by press molding, and in one form is carried out by applying pressures of at least 80 to 100 bars on the material.

The manufacturing method comprises a step of demolding (FIG. 4f) the woven fiber based composite part 1.

Alternatively, the manufacturing method then comprises a step of shrinking and/or machining the woven fiber based composite part 1.

Alternatively, the manufacturing method includes the hybridization of flanks of fibrous mat 4 or preforms cut in one or more of the variants of the fibrous mat 2 previously described, and/or with unidirectional continuous or discontinuous fiber laps, and/or with woven continuous fiber laps.

Thanks to the mat according to the present disclosure, after thermocompression of the material, a coverage of the fabric pieces 3 therebetween is obtained on the parts with constant or variable thickness, providing a proper homogeneity of the mechanical properties of stiffness and strength in any direction of the plane of the mat, thus providing a proper transfer of the forces/loads.

The present disclosure enables the conservation of several fiber orientations in the plane. The mechanical performances are maintained even for a part made of a pre-impregnated woven fiber material 1 with a very low thickness (equivalent to at least 1 time the thickness of the fabric piece 3). An almost isotropic material is obtained.

Depending on the length of the fibrous material flanks 4 (long or short), the thermocompression will induce a creeping starting from the center in the direction 8 (perpendicular to the plane of the flank when it is long (FIG. 4e)) or according to the direction 7 (short flank (FIG. 4d)).

After thermocompression, composite materials are obtained, with high mechanical properties and providing these same properties in the planes of the layers including the thin areas of these molded parts.

Depending on the distribution of the fibrous material flanks 4 in the mold 5, 6 (shape, stacks), the resin substantially creeps during the compression step.

As a general rule, upon the creeping during the thermocompression, it is desirable to have a viscosity of the resin which allows maintaining the desired resin/fiber stoichiometric ratio. In the case of very thin piece thickness, close to once the thickness of the fabric, it is possible to promote the desired creeping of the resin, by generating higher compaction pressures.

In the case of a part made of a pre-impregnated woven fiber material 1 having progressive and/or thin thicknesses, the creeping of the fabric pieces 3 or relative displacement of the latter relative to each other during the thermocompression, allows filling the total volume of the imprints 5, 6 of the mold.

An exemplary form is described below.

The mat of fabric piece(s) (or fibrous mat 2) is made from carbon fiber fabric(s) with a surface mass of about 280+/−30 g/m².

The fibers are made of carbon called high-strength or intermediate-modulus carbon and woven according to a low-shrinkage contexture of the type satin of 5 or twill of 2.

The fabric is impregnated with an epoxy thermosetting resin to form a pre-impregnated material having a mass rate comprised between about 70% of fibers and 30% of resin and 60% of fibers and 40% of resin.

The woven fiber lap intended to form the pre-impregnated fabric which will be cut into pieces to form the fabric pieces 3, has a compressed thickness of about 0.28 mm.

In the initial state, the pre-impregnated woven fiber fabric piece 3 or lap has an average thickness of 0.42 mm.

The impregnated fabric is cut into substantially square pieces of 35 mm side (i.e. 125 times the nominal thickness of the fabric) to form fabric pieces 3.

The fabric pieces 3 are disposed randomly in orientation and position on a planar surface, at an average of 3200 pieces/m² leading to the obtainment of a fabric piece mat with an average surface mass of 1.5 kg/m² in which there are, on average, 5 layers of fabric pieces 3.

This pre-impregnated woven fiber material being implemented into one single layer in a tooling, heated so that the matrix reaches a viscosity low enough to enable the pieces to slip relative to each other, such as for example less than 100 poises and more than 20 poises, and subjected to a pressure through the closure of the tooling, a pressure which may reach from 20 bars up to several hundred bars, can allow for part thicknesses ranging from about 0.5 mm to about 4 mm.

The mechanical properties of the molded material have elasticity moduli in the two main directions of a part surface in the range of 30 to 45 GPa and a mechanical tensile strength in the direction of the part plane higher than 300 MPa.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A pre-impregnated woven fiber material in a form of a fibrous mat comprising at least one layer of a plurality of pieces of fibrous fabric pre-impregnated with resin, wherein the pieces of fibrous fabric pre-impregnated with resin are positioned parallel to a plane of the fibrous mat and are oriented in different directions in the plane.

2. The pre-impregnated woven fiber material according to claim 1, wherein the pieces of fibrous fabric pre-impregnated with resin are oriented in the different directions such that each area of 2 cm² of the fibrous mat comprises across a thickness at least 4 distinct directions of fibers forming angles of more than 15° therebetween.

3. The pre-impregnated woven fiber material according to claim 1, wherein the entire fibrous fabric pre-impregnated with resin forming the fibrous mat has a shrinkage of less than 5%.

4. The pre-impregnated woven fiber material according to claim 1, wherein a ratio between a length and a thickness of the pieces of fibrous fabric pre-impregnated with resin of the fibrous mat is between 60 and 250.

5. The pre-impregnated woven fiber material according to claim 4, wherein the ratio between the length and the thickness of the pieces of fibrous fabric pre-impregnated with resin of the fibrous mat is between 80 and 200.

6. The pre-impregnated woven fiber material according to claim 5, wherein the ratio between the length and the thickness of the pieces of fibrous fabric pre-impregnated with resin of the fibrous mat is between 100 and 180.

7. The pre-impregnated woven fiber material according to claim 1, wherein the pieces of fibrous fabric pre-impregnated with resin of the fibrous mat have a width greater than a quarter of a length of the pieces of fibrous fabric.

8. The pre-impregnated woven fiber material according to claim 1, wherein the pieces of fibrous fabric pre-impregnated with resin of the fibrous mat have a width greater than half of a length of the pieces of fibrous fabric.

9. The pre-impregnated woven fiber material according to claim 1, wherein the pieces of fibrous fabric pre-impregnated with resin of the fibrous mat have a width equal to a length of the pieces of fibrous fabric.

10. The pre-impregnated woven fiber material according to claim 1, wherein the fibrous mat has an average surface mass at least 2 times greater than a surface mass of the fibrous fabric pre-impregnated with resin and less than 10 times the surface mass of the fibrous fabric pre-impregnated with resin.

11. The pre-impregnated woven fiber material according to claim 1, wherein the fibrous mat has an average surface mass between 1 kg/m² and 3 kg/m².

12. The pre-impregnated woven fiber material according to claim 1, wherein the pieces of fibrous fabric are impregnated with a thermosetting polymer resin adapted to be crosslinked by a thermocompression operation.

13. The pre-impregnated woven fiber material according to claim 1, wherein the pieces of fibrous fabric are impregnated with a thermoplastic polymer resin adapted to be solidified by a thermocompression step.

14. The pre-impregnated woven fiber material according to claim 1, wherein the pieces of fibrous fabric pre-impregnated with resin of the fibrous mat have a triangular, rectangular, or hexagonal shape.

15. The pre-impregnated woven fiber material according to claim 1 further comprising pre-impregnated unidirectional fiber lap pieces.

16. A part made of a composite material formed by thermocompression of at least one pre-impregnated woven fiber material in a form of a fibrous mat according to claim 1.

17. The pre-impregnated woven fiber material according to claim 1, wherein at least one portion of the fibrous fabric pre-impregnated with resin forming the fibrous mat has a shrinkage of less than 5%.
